(19) United States
(12) Patent Application Publication
(10) Pub. No.: US 2019/0149910 A1
(43) Pub. Date: May 16, 2019

(54) SPEAKER STRUCTURE

(71) Applicant: Acer Incorporated, New Taipei City (TW)

(72) Inventors: Po-Yi Lee, New Taipei City (TW); Chuan-Hua Wang, New Taipei City (TW); Chi-Hung Lai, New Taipei City (TW); Pin-Chueh Lin, New Taipei City (TW); Hung-Chi Chen, New Taipei City (TW)

(73) Assignee: Acer Incorporated, New Taipei City (TW)

(21) Appl. No.: 16/100,191

(22) Filed: Aug. 9, 2018

(30) Foreign Application Priority Data
Nov. 14, 2017 (TW) 106216902

(51) Int. Cl. H04R 1/28; H04R 9/06; G10K 11/00; H04R 1/02

(52) U.S. Cl. CPC H04R 1/2896; H04R 9/06; G10K 11/002; G10K 11/172; H04R 1/02; H04R 2400/03; H04R 2499/11; G10K 11/004

(57) ABSTRACT

A speaker structure adapted to an electronic device is provided. The speaker structure includes a casing, a speaker and a vibration suppression element. The casing is fixed above a chassis of the electronic device. The speaker is disposed in the casing. The vibration suppression element connects the casing and the chassis. The vibration suppression element includes a spring and an elastic body. The spring is encapsulated by the elastic body.

### CROSS-REFERENCE TO RELATED APPLICATION

This application claims the priority benefit of Taiwan application serial no. 106216902, filed on Nov. 14, 2017. The entirety of the above-mentioned patent application is hereby incorporated by reference herein and made a part of this specification.

### BACKGROUND OF THE INVENTION

### Field of the Invention

The invention relates to a speaker structure, and particularly relates to a speaker structure adapted to an electronic device.

### Description of Related Art

Since electronic devices such as notebooks, tablet computers or smart phones, etc. have advantages of easy carry and instant information transceiving or processing capability, they have become indispensible tools for modern people. Taking the notebook as an example, a speaker is configured therein to receive audio signals to send sounds. The speaker vibrates during an operation process, and a corresponding vibration wave thereof may influence electronic parts on the device or electronic parts in the device to even cause a resonance effect.

### SUMMARY OF THE INVENTION

The invention is directed to a speaker structure, which is able to reduce a resonance effect.

The invention provides a speaker structure adapted to an electronic device. The speaker structure includes a casing, a speaker and a vibration suppression element. The casing is fixed above a chassis in the electronic device. The speaker is disposed in the casing. The vibration suppression element connects the casing and the chassis. The vibration suppression element includes a spring and an elastic body. The elastic body encapsulates the spring.

According to the above description, the speaker structure of the invention is adapted to absorb a vibration wave generated by the speaker through the vibration suppression element, so as to avoid influencing the electronic parts in the electronic device to reduce the resonance effect.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a partial schematic diagram of a speaker structure and an electronic device using the speaker structure according to an embodiment of the invention.

FIG. 2 is a cross-sectional view of FIG. 1 along a section line I-I.

FIG. 3 is three-dimension cross-sectional view of a vibration suppression element of FIG. 1.

FIG. 4 is a partial cross-sectional view of a speaker structure and an electronic device using the speaker structure according to another embodiment of the invention.

FIG. 5 is three-dimension cross-sectional view of a vibration suppression element of FIG. 4.

### DESCRIPTION OF EMBODIMENTS

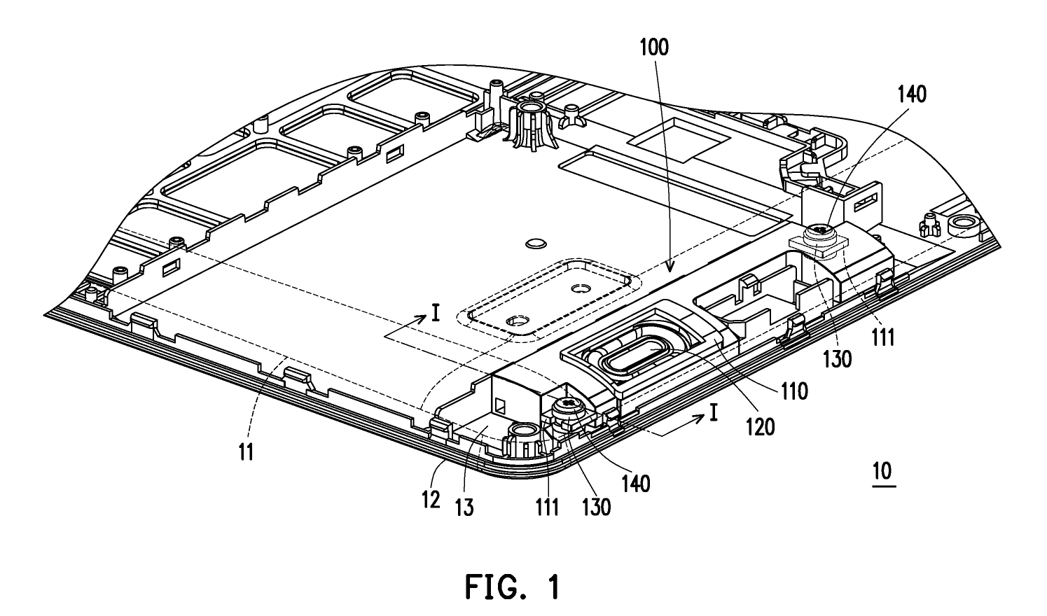

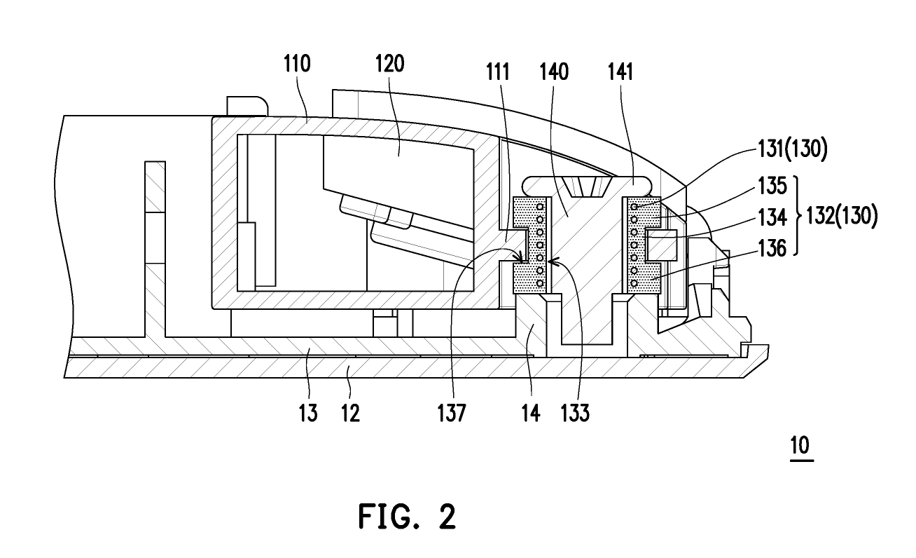

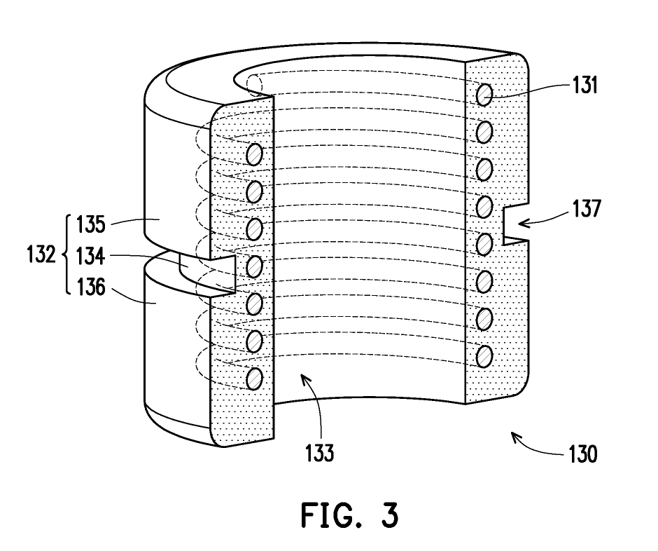

FIG. 1 is a partial schematic diagram of a speaker structure and an electronic device using the speaker structure according to an embodiment of the invention. FIG. 2 is a cross-sectional view of FIG. 1 along a section line I-I. FIG. 3 is three-dimension cross-sectional view of a vibration suppression element of FIG. 1. For clarity's sake, a first casing 11 of the electronic device 11 of FIG. 1 is drawn in dotted lines. Referring to FIG. 1 to FIG. 3, in the present embodiment, the electronic device 10 may be a main body (a body including a keyboard) of a notebook, or a docking station capable of combining with a tablet computer, or a smart phone, a tablet computer or a display. The type of the electronic device is not limited by the invention, and as long as the electronic device is configured with a speaker therein, it is considered to be within the scope of the invention.

The speaker structure 100 is disposed in the electronic device 10, where the electronic device 10 includes a first housing 11, a second housing 12 and a chassis 13. The first housing 11 and the second housing 12 are assembled to each other, and the chassis 13 is fixed between the first housing 11 and the second housing 12. On the other hand, the speaker structure 100 is disposed between the first housing 11 and the second housing 12, and is located between the first housing 11 and the chassis 13. The speaker structure 100 includes a casing 110, a speaker 120 and a vibration suppression element 130, where the casing 110 is fixed above the chassis 13, and the speaker 120 is disposed in the casing 110. Further, the casing 110 does not contact the first housing 11 and does not directly contact the chassis 13, but is connected to the chassis 13 through the vibration suppression element 130. Therefore, the casing 110 is supported by the vibration suppression element 130 to keep a gap with the chassis 13.

The vibration suppression element 130 is connected to the casing 110 and the chassis 13, further, the casing 110 includes a locking portion 111, where the vibration suppression element 130 penetrates through a through hole of the locking portion 111, and one end of the vibration suppression element 130 leans against a convex column 14 of the chassis 13. Though an engaging relationship between the vibration suppression element 130 and the locking portion 111, the vibration suppression element 130 is prevented from being easily detached from the locking portion 111. In the present embodiment, the vibration suppression element 130 includes a spring 131 and an elastic body 132, where the spring 131 may be a compression spring, and the elastic body 132 may be silicone, rubber or foam used for encapsulating the spring 131, and the elastic body 132 and the spring 131 have different elastic coefficients. The speaker structure 120 further includes a locking member (for example, a screw) 140, which penetrates through the elastic body 132 of the vibration suppression element 130 and penetrates into the convex column 14 of the chassis 13 for locking to the chassis 13. Based on the engaging relationship between the vibration suppression element 130 and the locking portion 111 of the casing 110, and a locking relationship among the locking member 140, the vibration suppression element 130 and the chassis 13, the casing 110 supported by the vibration suppression element 130 is fixed above the chassis 13.

The elastic body 132 has a through hole 133, such that the locking member 140 is adapted to penetrate there through, and the spring 131 surrounds the through hole 133. In the present embodiment, the elastic body 132 includes a main portion 134 and a first leaning portion 135 and a second leaning portion 136 connected to the main portion 134, where the first leaning portion 135 and the second leaning portion 136 are respectively located at two opposite sides of the main portion 134, and the through hole 133 penetrates through the first leaning portion 135, the main portion 134 and the second leaning portion 136. The main portion 134 penetrates through the through hole of the locking portion 111, and the first leaning portion 135 and the second leaning portion 136 are respectively located at two opposite sides of the locking portion 111. An outer diameter of the main portion 134 is smaller than an outer diameter of the first leaning portion 135 and an outer diameter of the second leaning portion 136, and the outer diameter of the first leaning portion 135 may be equal to the outer diameter of the second leaning portion 136, so as to define a groove 137 on the elastic body 132. In the present embodiment, the groove 137 and the locking portion 111 are engaged, where a head portion 141 of the locking member 140 leans against the locking portion 111 through the first leaning portion 135, and the locking portion 111 leans against the convex column 14 on the chassis 13 through the second leaning portion 136. Further, the outer diameter of the first leaning portion 135 and the outer diameter of the second leaning portion 136 are respectively greater than an inner diameter of the through hole of the locking portion 111, where the first leaning portion 135 is located between the head portion 141 of the locking member 140 and the locking portion 111, and the second leaning portion 136 is located between the locking portion 111 and the convex column 14 on the chassis 13.

In the present embodiment, the numbers of the vibration suppression element 130, the locking member 140 and the locking portion 111 may be respectively plural, and the numbers are equal to each other, and above elements are distributed around the casing 110. In this way, a bonding strength and stability between the casing 110 and the chassis 13 are improved, and a vibration suppressing effective is strengthened. The first leaning portion 135, the main portion 134 and the second leaning portion 136 are respectively cylinders, and the spring 131 is embedded in the first leaning portion 135, the main portion 134 and the second leaning portion 136. A pitch, a wire diameter and a free length of the spring 131 may be adjusted (i.e. to change the elastic coefficient of the spring 131) according to a setting of the system (i.e. the electronic device 10), so as to absorb the vibration wave generated by the speaker 120 or change a vibration frequency through coordination of the spring 131 and the elastic body 132 to avoid interfering the electronic parts in the system (i.e. the electronic device 10), and reduce the resonance effect. Further, the speaker 120 is carried by the casing 110, and the casing 110 is connected to the chassis 13 through the vibration suppression element 130, so that the vibration wave generated by the speaker 120 is transmitted to the chassis 13 sequentially through the casing 110 and the vibration suppression element 130, and the vibration wave passing through the vibration suppression element 130 may be absorbed or a frequency thereof is changed, so that the resonance effect may be mitigated.

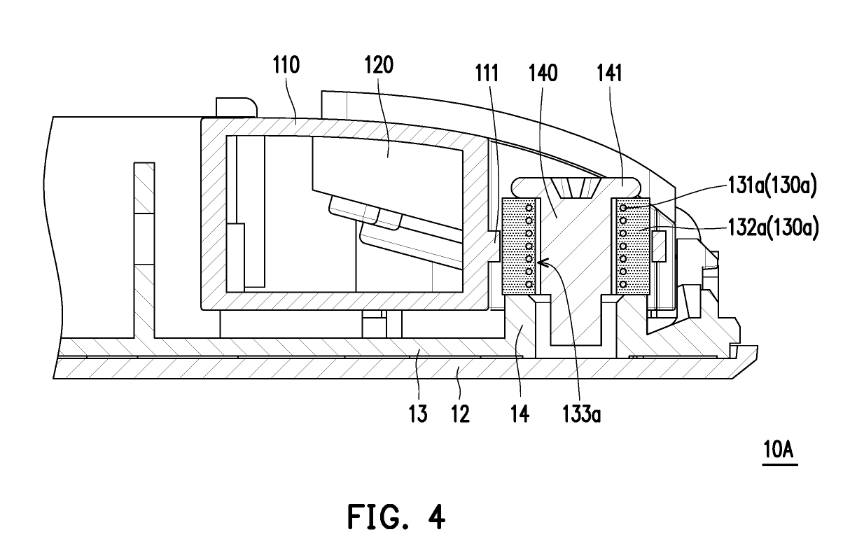

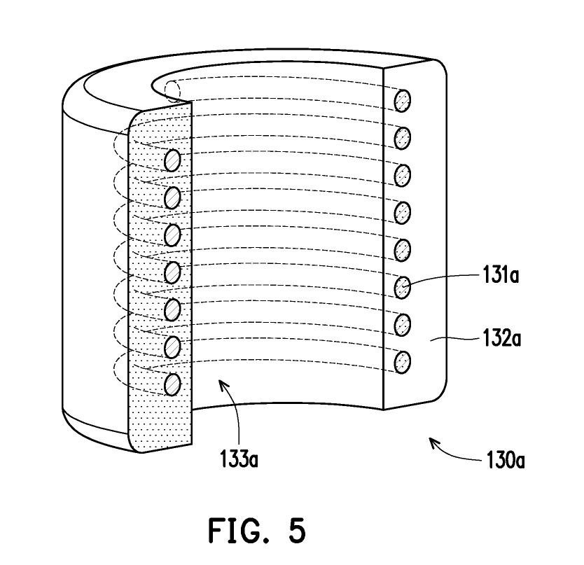

FIG. 4 is a partial cross-sectional view of a speaker structure and an electronic device using the speaker structure according to another embodiment of the invention. FIG. 5 is three-dimension cross-sectional view of a vibration suppression element of FIG. 4. Referring to FIG. 4 and FIG. 5, the speaker structure 100A of the present embodiment is similar to the speaker structure 100 of the aforementioned embodiment, and principles for absorbing the vibration wave or changing a frequency of the vibration wave of the two embodiments are substantially the same or similar, so that details thereof are not repeated. Further, the elastic body 132a of the vibration suppression element 130a of the present embodiment is set equal diameter, which is substantially a cylinder, and the spring 131a is embedded in the cylinder. The elastic body 132 penetrates through the through hole of the locking portion 111, where two opposite ends of the elastic body 132a respectively lean against the head portion 141 of the locking member 140 and the convex column 14 on the chassis 13, and the locking member 140 may penetrate through the through hole 133a of the elastic body 132a. On the other hand, the electronic device 10A of the present embodiment is substantially the same or similar to the electronic device 10 of the above embodiment, and detail thereof is not repeated.

In summary, the speaker structure of the invention is adapted to absorb a vibration wave generated by the speaker or change a frequency of the vibration wave through the vibration suppression element, so as to avoid influencing the electronic parts in the electronic device to reduce the resonance effect. On the other hand, the vibration suppression element is composed of the elastic body and the spring embedded in the elastic body, and the spring and the elastic body have different elastic coefficients, and through the coordination of the spring and the elastic body, the effect of absorbing the vibration wave or changing the frequency of the vibration wave is strengthened.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A speaker structure, adapted to an electronic device, comprising:
a casing, fixed above a chassis in the electronic device;
a speaker, disposed in the casing; and
a vibration suppression element, connecting the casing and the chassis, and comprising:
a spring; and
an elastic body, encapsulating the spring.

2. The speaker structure as claimed in claim 1, wherein the casing comprises a locking portion, and the speaker structure further comprises a locking member, the vibration suppression element penetrates through the locking portion, and the locking member penetrates through the elastic body of the vibration suppression element and is locked to the chassis, so as to fix the casing above the chassis.

3. The speaker structure as claimed in claim 2, wherein the elastic body has a through hole, the locking member penetrates the through hole, and the spring surrounds the through hole.

4. The speaker structure as claimed in claim 2, wherein the elastic body includes a main portion and two leaning portions connected to the main portion, the two leaning portions are respectively located at two opposite sides of the main portion, the main portion penetrates through the locking portion, and the two leaning portions are respectively located at two opposite sides of the locking portion.

5. The speaker structure as claimed in claim 4, wherein a head portion of the locking member leans against the locking portion through one of the leaning portions.

6. The speaker structure as claimed in claim 4, wherein the locking portion leans against the chassis through one of the leaning portions.

7. The speaker structure as claimed in claim 1, wherein the elastic body is set equal diameter.

8. The speaker structure as claimed in claim 1, wherein an amount of the vibration suppression element is plural, and the vibration suppression elements are distributed around the casing.

9. The speaker structure as claimed in claim 1, wherein the elastic body is silicone, rubber or foam.
